(19) United States
(12) Patent Application Publication
(10) Pub. No.: US 2015/0133147 A1
(43) Pub. Date: May 14, 2015

(54) WIRELESS INDOOR LOCATION AIR INTERFACE PROTOCOL

(71) Applicant: Intel Corporation, Santa Clara, CA (US)

(72) Inventor: Gaby Prechner, Rishon Lezion (IL)

(21) Appl. No.: 14/119,947

(22) PCT Filed: Oct. 25, 2013
(86) PCT No.: PCT/US2013/066892

§ 371 Date: Nov. 25, 2013

(51) Int. Cl. G01S 5/06

(52) U.S. Cl. CPC G01S 5/06
USPC 455/456.1

(57) ABSTRACT

Embodiments of a system and method for establishing a physical location of a device are generally described herein. In some embodiments a device may include a wireless device configured to communicate with an access point through the use of a wireless protocol, and to receive timing information from the access point. In some embodiments a device may receive unsolicited timing information from one or more network devices that intercept communications between the device and the access point. In some embodiments a module in a device may determine a range between the device and the access point or the one or more network devices. In some embodiments a plurality of access points may monitor a communication protocol and provide unsolicited timing information in response to communications between a device and an access point without establishing a connection with the device.

### TECHNICAL FIELD

Embodiments pertain to wireless communications. Some embodiments relate to the use of wireless geo-location, more specifically, some embodiments relate to determining a location of a device within a space equipped with a wireless network.

### BACKGROUND

Accurately locating wireless network devices indoors is hampered by the general unavailability of signals from global navigation and positioning satellite systems and the computational cost associated with performing numerous location determinations from terrestrial sources. Thus there are general needs for systems and methods that reduce costs associated with accurately locating wireless devices indoors or locations where other signals are unavailable to determine position.

### BRIEF DESCRIPTION OF THE DRAWINGS

Some embodiments are illustrated by way of example and not limitation in the figures of the accompanying drawings in which:

FIG. 1 is a block diagram of an example communication system in accordance with some embodiments;

FIG. 2 is a block diagram of an example wireless communication system in accordance with some embodiments;

FIG. 3 is a swim-lane chart illustrating the operation of a method for determining a position of a device with an access point in accordance with some embodiments;

FIG. 4 is a swim-lane chart illustrating the operation of a method for monitoring interaction of a device with an access point in accordance with some embodiments;

FIG. 5 is a flow diagram illustrating an example method for determining a position of a device in accordance with some embodiments;

FIG. 6 is a diagram illustrating an example interaction between a device a multiple access points in accordance with some embodiments;

FIG. 7 is a block diagram illustrating a mobile device in accordance with some embodiments;

FIG. 8 is a diagrammatic representation of a machine in the example form of a computer system within which a set of instructions for causing the machine to perform any one or more of the methodologies discussed herein may be executed; and

FIG. 9 illustrates a functional block diagram of user equipment (UE) in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Various techniques and configurations described herein provide for a location discovery technique used in conjunction with wireless communications and network communications. The presently described location techniques may be used in conjunction with wireless communication between devices and access points. For example, a wireless local area network (e.g., Wi-Fi) may be based on, or compatible with, one of the Institute of Electrical and Electronics Engineers (IEEE) 802.11 standards.

With some network technologies, establishing the location of a device makes use of time of flight (TOF) calculations to calculate the distances between the device and multiple access points. For example, a device may request TOF information from two or more access points in order to establish a physical distance from each individual access point, and thereby determining an approximate physical location of the device with respect to the access points. In an example where the physical location of the access points is known, the access points may provide the device with that location information such that the device, alone or in conjunction with the access points, may determine a precise physical location of the device, for example, as a set of latitude and longitude values in a navigational coordinate system.

In connection with the presently described techniques, a wireless communications device is utilized to establish a connection with a wireless communications access point, and to receive location information from an additional access point that may monitor the establishment of the connection. In an example, a device requests, at a departure time t1, a TOF exchange with a first access point. At an arrival time t2, the first access point receives the request, and in response, at a departure time t3, sends an acknowledgment of the request. At an arrival time t4 the device receives the acknowledgement from the access point. Subsequently, the access point may transmit the time values t2 and t3 to the device.

A second access point, and one or more other access points, may monitor the exchange between the device and the first access point and provide additional location information. For example, at time t5 the second access point may receive the request from the device that was sent to the first access point, and at time t6 the second device may receive the acknowledgement that was transmitted from the first access point to the device. These time values t5 and t6 may be broadcast by the second access point and received by the device. The device may utilize some or all of the received time values to determine its range and location with respect to the first access point, the second access point and the one or more access other points. In this manner the device may determine a location based on the device's distance from the access points without performing a complete request-acknowledgement exchange with the second access point or the one or more other access points.

In an example, the device computes a time of arrival (TOA) and performs a full time of flight packet exchange only once per channel. In this manner the device can save power, and maintain a high data throughput for user data (e.g., web content, voice calls, text messages, or e-mail) even when performing device location or navigation operations. Although the accuracy of a single TOF exchange with a single access point may be less precise than a full TOF exchange with multiple access points, the TOF exchange may be performed only once per channel, and in this manner the device may perform more measurements for each location computation and thereby increase accuracy performance over other location detection techniques.

Additionally, in contrast to other techniques for performing hyperbolic location, the techniques discussed herein do not require a managed or synchronized network. The timing for TOF location may be controlled by an individual device. Even in scenarios where the device is a SP with only one antenna as most of the measurements are made by the access point, higher accuracy may be achieved as a result of using MIMO at the access point side of the exchange.

These location techniques may facilitate the determination of a device location using any of a variety of network protocols and standards in licensed or unlicensed spectrum bands, including Wi-Fi communications performed in connection with an IEEE 802.11 standard (for example, Wi-Fi communications facilitated by fixed access points), 3GPP LTE/LTE-A communications (for example, LTE Direct (LTE-D) communications established in a portion of an uplink segment or other designated resources), machine-to-machine (M2M) communications performed in connection with an IEEE 802.16 standard, and the like.

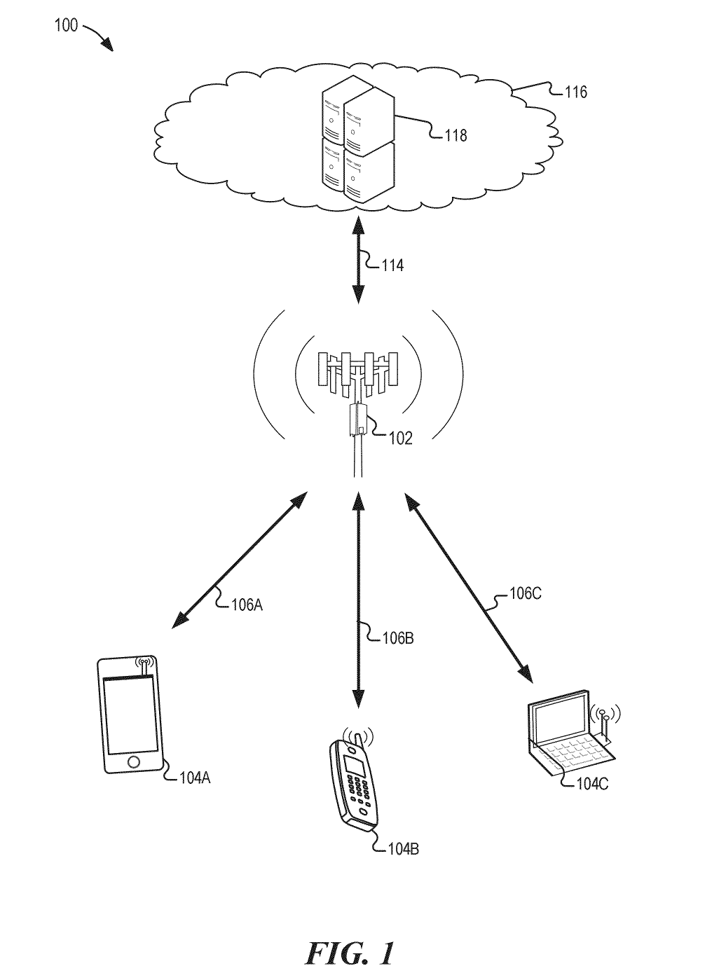

FIG. 1 provides an illustration of an example configuration of a communication network architecture 100. Within the communication network architecture 100, a carrier-based network such as an IEEE 802.11 compatible wireless access point or a LTE/LTE-A cell network operating according to a standard from a 3GPP standards family is established by network equipment 102. The network equipment 102 may include a wireless access point, a Wi-Fi hotspot, or an enhanced or evolved node B (eNodeB) communicating with communication devices 104A, 104B, 104C (e.g., a user equipment (UE) or a communication station (STA)). The carrier-based network includes wireless network connections 106A, 106B, and 106C with the communication devices 104A, 104B, and 104C, respectively. The communication devices 104A, 104B, 104C are illustrated as conforming to a variety of form factors, including a smartphone, a mobile phone handset, and a personal computer having an integrated or external wireless network communication device.

The network equipment 102 is illustrated in FIG. 1 as being connected via a network connection 114 to network servers 118 in a cloud network 116. The servers 118 may operate to provide various types of information to, or receive information from, communication devices 104A, 104B, 104C, including device location, user profiles, user information, web sites, e-mail, and the like. The techniques described herein enable the determination of the location of the various communication devices 104A, 104B, 104C, with respect to the network equipment 102 without requiring the various communication devices to establish a communication session with more than one network equipment.

Communication devices 104A, 104B, 104C may communicate with the network equipment 102 when in range or otherwise in proximity for wireless communications. As illustrated, the connection 106A may be established between the mobile device 104A (e.g., a smartphone) and the network equipment 102; the connection 106B may be established between the mobile device 104B (e.g., a mobile phone) and the network equipment 102; and the connection 106C may be established between the mobile device 104C (e.g., a personal computer) and the network equipment 102.

The wireless communications 106A, 106B, 106C between devices 104A, 104B, 104C may utilize a Wi-Fi or IEEE 802.11 standard protocol, or a protocol such as the current 3rd Generation Partnership Project (3GPP) long term evolution (LTE) time division duplex (TDD)-Advanced systems. In one embodiment, the communications network 116 and network equipment 102 comprises an evolved universal terrestrial radio access network (EUTRAN) using the 3rd Generation Partnership Project (3GPP) long term evolution (LTE) standard and operating in time division duplexing (TDD) mode. The devices 104A, 104B, 104C may include one or more antennas, receivers, transmitters, or transceivers that are configured to utilize a Wi-Fi or IEEE 802.11 standard protocol, or a protocol such as 3GPP, LTE, or TDD-Advanced or any combination of these or other communications standards.

Antennas in or on devices 104A, 104B, 104C may comprise one or more directional or omnidirectional antennas, including, for example, dipole antennas, monopole antennas, patch antennas, loop antennas, microstrip antennas or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, antennas may be effectively separated to utilize spatial diversity and the different channel characteristics that may result between each of the antennas and the antennas of a transmitting station. In some MIMO embodiments, antennas may be separated by up to 1/10 of a wavelength or more.

In some embodiments, the mobile device 104A may include one or more of a keyboard, a display, a non-volatile memory port, multiple antennas, a graphics processor, an application processor, speakers, and other mobile device elements. The display may be an LCD screen including a touch screen. The mobile device 104B may be similar to mobile device 104A, but does not need to be identical. The mobile device 104C may include some or all of the features, components, or functionality described with respect to mobile device 104A.

A base station, such as an enhanced or evolved node B (eNodeB), may provide wireless communication services to communication devices, such as device 104A. While the exemplary communication system 100 of FIG. 1 depicts only three devices users 104A, 104B, 104C any combination of multiple users, devices, servers and the like may be coupled to network equipment 102 in various embodiments. For example, three or more users located in a venue, such as a building, campus, mall area, or other area, and may utilize any number of mobile wireless-enabled computing devices to independently communicate with network equipment 102. Similarly, communication system 100 may include more than one network equipment 102. For example, a plurality of access points or base stations may form an overlapping coverage area where devices may communicate with at least two instances of network equipment 102.

Although communication system 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, application specific integrated circuits (ASICs), radio-frequency integrated circuits (RFICs) and combinations of various hardware and logic circuitry for performing at least the functions described herein. In some embodiments, the functional elements of system 100 may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, system 100 may include one or more processors and may be configured with instructions stored on a computer-readable storage device.

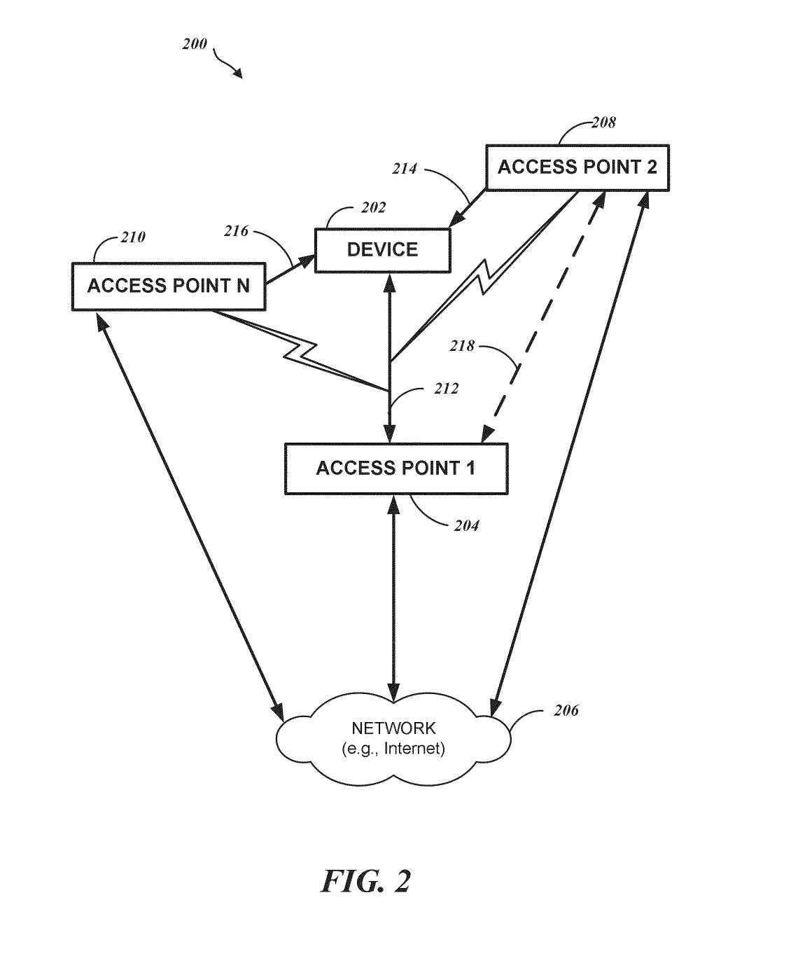

FIG. 2 is a block diagram of an example wireless communication system 200 that may utilize the communication network architecture 100 of FIG. 1. The exemplary communication system 200 may include a device 202 that is capable of wireless communication (e.g., a user equipment (UE) or communication station (STA)). In an example, the device 202 may be a mobile computing device such as a cellular phone, a smartphone, a laptop, a tablet computer, a personal digital assistant or other electronic device capable of wireless communication. A first access point 204 may, for example, be a base station or a fixed wireless router. The device 202 may establish a communication link 212 with the first access point 204 in order to reach a network 206 such as the Internet. In an example, the device 202 may communicate with a service provider (not depicted), for example, through the first access point 204 and the network 206.

In an example, a second access point 208 or a third access point 210 may monitor the communications link 212 between the device 202 and the first access point 204. The device 202 may initiate a time-of-flight TOF protocol with the first access point 204. The second access point 208 or the third access point 210 may also receive the TOF protocol exchange in communications 212. The second access point 208 or the third access point 210 may provide timing and/or location information to the device 202 based on the interception of the TOF protocol exchange. The timing information may include time-of-arrival or time-of-departure data with respect to the TOF protocol exchange that are local to the second access point 208 or the third access point 210. The location information may include the location of the second access point 208 or the third access point 210. In this manner the device 202 may receive TOF data without establishing a direct connection with the second access point 208 or the third access point 210. The exact nature of the protocol for the TOF exchange may vary in which device initiates the exchange or the number of actual request-acknowledge pairs are utilized. In an example, the second access point 208 may broadcast a packet 214 to device 202 that contains the timing information as determined by the second access point 208. In a similar manner, the third access point 210 may broadcast a second packet 216 to the device 202 that contains the timing information as determined by the third access point 210.

In an example, the second access point 208 may have, or establish, a connection 218 with the first access point 204. In a similar manner, the third access point 210 may also communicate with the first access point 204 independently or through the second access point 208. The connection 218 may be via a wireless communication protocol, through a wired connection, or established through the network 206. The connection 218 may be utilized to provide the location information determined by the second access point 208 or the third access point 210 to the first access point 204. In this manner the first access point 210 may provide location information from two or more access points to the device 202 after the device 202 has established communication link 212.

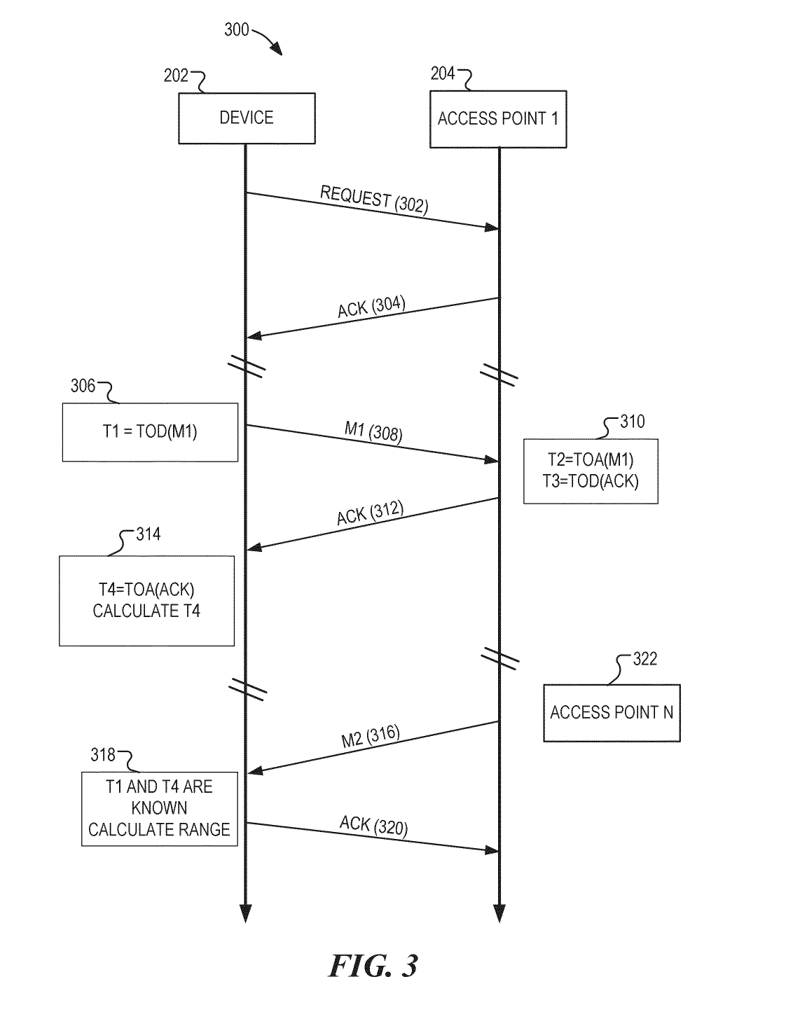

FIG. 3 is a swim-lane chart illustrating the operation of a method 300 for determining a position of a device with an access point in accordance with some embodiments. For example, the device 202 and the first access point 204 of FIG. 2 may be configured to perform the method 300, or portions thereof.

In an example, the device 202 may transmit a request 302 to establish communication with the first access point 204. The first access point 204 may respond with an acknowledgement 304 indicating the capability of providing location determination services. At 306, time t1, the device 202 may send a first message 308 that may include a query time of flight (TOF) request to the first access point 204. At 310, an arrival time t2, the first access point 204 receives the first message 308, and in response, at a departure time t3, sends an acknowledgment 312 to the device 202. At 314, arrival time t4, the device 202 receives the acknowledgement 312 from the access point 204.

The acknowledgement 312 may include data that indicates the arrival time t2 and the departure time t3; or optionally and subsequently, the access point 204 may transmit the time values t2 and t3 to the device 202 in a subsequent message 316. At 318, the device 202 has received the arrival time t2 and the departure time t3 from the access point 204, and may have determined time t1 and arrival time t4 such that the device 202 may calculate a range between the device 202 and the access point 204.

An additional access point 322, and one or more other access points, may monitor the exchange between the device 202 and the first access point 204 as depicted in FIG. 3. The additional access point 322 may provide additional location information based on the receipt of one or more of: the request 302, the acknowledgement 304, the first message 308, or acknowledgment 312.

For example, at time t5 the additional access point 322 may receive the request 302 from the device 202 that was sent to the first access point 204, and at time t6 the additional access point 322 may receive the acknowledgement 304 that was transmitted from the first access point 204 to the device 202. These time values t5 and t6 may be broadcast by the additional access point 322 and received by the device 202. The device 202 may utilize some or all of the received time values t2, t3, t5 or t6 to determine a range or a location of the device 202 with respect to the first access point 204, the second access point 322, and the one or more access other points. In this manner the device 202 may determine a location based on the device's distance from the access points without performing a complete request-acknowledgement exchange with the additional access point 322 or the one or more other access points.

In an example, the access point 204 may communicate the time values t2 and t3 to the additional access point 322, or the additional access point 322 may communicate the time values t5 and t6 to the access point 204. The access point 204 and the additional access point 322 may communicate over a wired, wireless, or other communication link. In an example, the access point 204 and the additional access point 322 are both connected to a local area network by a router, a bridge, a direct physical connection, or another communication link.

In an example, the access point 204 may receive the time t1 and the arrival time t4 from the device 202, and may utilize the time values t1, t2, t3 and t4 to calculate a range between the device 202 and the access point 204. In an example, the access point 204 may receive the range or location determined at 318 from the device 202. The access point 204 may communicate the calculated or received range or location to the additional access point 322, or another device, server, or application.

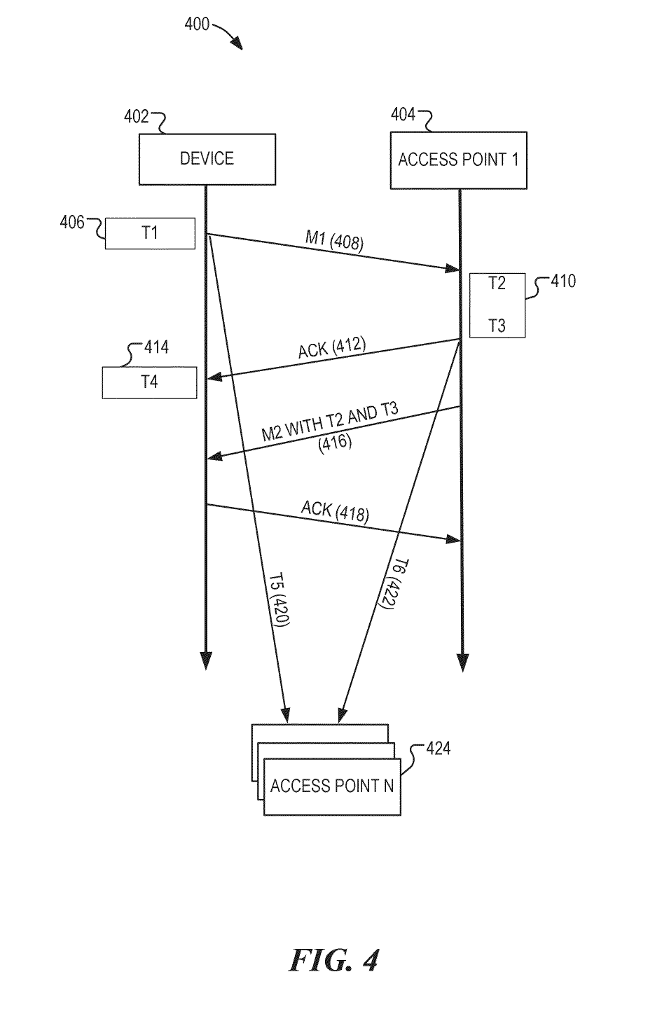

FIG. 4 is a swim-lane chart illustrating the operation of a method 400 for monitoring interaction of a device 402 with an access point 404. The method 400 may begin at time T1 406 with the device 402 transmitting a first message 408 to the access point 404. In an example, the first message 408 may include a request to establish a connection between device 402 and access point 404. In an example, the first message 408 may include a request to determine a distance between the device 402 and the access point 404. The request may specify that the distance is to be computed by the device 402 based on a time-of-flight calculation.

At 410, the method 400 may continue with the access point 404 receiving the first message 408 at time T2, processing the message, and transmitting an acknowledgement 412 at time T3. The difference between time T2 and time T3 may represent a time period that the access point 404 utilized to receive the first message 408, process the first message, and transmit the acknowledgement 412. In an example, the first message 408 and the acknowledgement 412 may be transmitted by the device 402 and the access point 404, in a single channel of a multi-channel protocol.

At 414, upon receipt of the acknowledgement 412, the device 202 may determine time T4. The difference between time T4 and time T1 may be utilized by the device to determine a complete round-trip request-response time between the device 402 and the access point 404. The access point 404 may transmit a second message 416 that includes a payload with time T2 and time T3. In an alternative example, the acknowledgement 412 and the second message 416 may be combined into a single response that includes the payload with time T2 and time T3. The device 402 may transmit a second acknowledgement 418 to the access point 404 in response to receiving the second message 416.

At time T5 420, one or more additional access points 424 may, receive the first message 408. At time T6 422, the one or more additional access points 424 may receive the acknowledgement 412. The one or more additional access points 424 may also receive the second message 416 that includes the payload with time T2 and time T3.

Upon receipt of the second message 416 each of one or more additional access points 424 may transmit a broadcast message that includes time T5 and time T6. The device 402 may receive the broad cast message from each of one or more additional access points 424.

The device 402 may perform a differential computation and derive the range from each of one or more additional access points 424 without having to perform a time of flight exchange or compute a time of arrival. In an example, EQUATION 1 provides an algorithm to determine a range (R) between the device 402 and each of one or more additional access points 424 where I equals the number of the access point, i equals 2 through N, N equals the number of access points that respond in a channel utilized by the device 402 and the access point 404, and c equals the speed of light.

$$\{ \begin{matrix}{APi : Device \text{-} AP 1}_{} = c \cdot [ t 5 - ( \begin{matrix}t 6 - \\ ( t 3 - t 2 + {Device \text{-} AP 1}_{} / c )\end{matrix} ) ] \\ {APi : Device \text{-} AP 1}_{} \cdot c = {R}_{AP 1 \text{-} AP 2} - {R}_{Device \text{-} APi}\end{matrix} {}^{yields} {R}_{Device \text{-} APi} = {R}_{AP 1 \text{-} AP 2} - {AP 2 : Device \text{-} APi}_{} \cdot c \qquad EQUATION 1$$

Optionally, method 400 may include one or more operations defined by any of a variety of network protocols and standards in licensed or unlicensed spectrum bands, including Wi-Fi P2P communications performed in connection with an IEEE 802.11 standard (for example, Wi-Fi Direct communications facilitated by software access points (Soft APs)), 3GPP LTE/LTE-A communications (for example, LTE Direct (LTE-D) communications established in a portion of an uplink segment or other designated resources), machine-to-machine (M2M) communications performed in connection with an IEEE 802.16 standard, and the like.

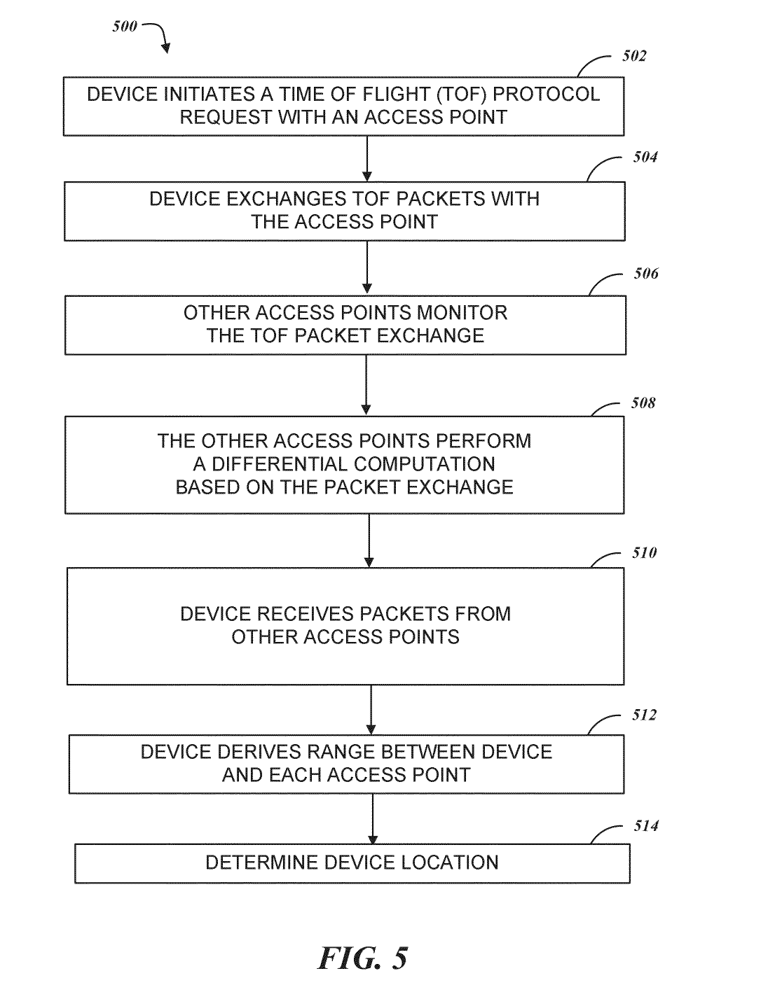

FIG. 5 is a flowchart illustrating an example method 500 for determining a position of a device in accordance with some embodiments. In an example, the method 500 may be performed by the device 202 of FIG. 2 in an attempt to establish a communication session with the access point 204 of FIG. 2.

At 502, the method 500 may begin with a device attempt to discover available wireless networks. The wireless networks may utilize a Wi-Fi or IEEE 802.11 standard protocol, or a protocol such as the current 3GPP, LTE, or TDD-Advanced. The device may initiate a time of flight (TOF) protocol request with an access point.

At 504, the device may exchange TOF packets with the access point. In an example, the TOF packets received by the device from the access point may include data that indicate a time of arrival of the request at the access point, and a time of reply corresponding to the transmission of a response to the request by the access point.

At 506, one or more other access point may monitor the TOF packet exchange. In an example, the one or more other access points may broadcast one or more packets that include data that indicate a request time of arrival corresponding to the receipt of the request at the one or more other access points, and a response time of arrival corresponding to the receipt of the response transmitted from the access point.

At 508, the one or more other access points may perform a differential computation based on the packet exchange between the device and each access point. In an example, the one or more other access points may refrain from establishing a network connection with the device.

At 510, the device may receive one or more packets from the other access points. The one or more packets may include timing data that indicate the request time and the response time as determined by each one of the access points. In an example, the device may not respond to the one or more other access points after receiving the one or more packets. The one or more packets may include timing data that was observed or calculated by the one or more other access points. In an example, the one or more packets may include location information from one or more of the one or more other access points.

At 512, the device may derive a range between the device and each access point based at least in part on the timing data included in the one or more packets received from the one or more other access points.

At 514, the device may determine a location of the device. In an example, the location may be an absolute geographic location. In an example, one or more of the access points may provide their respective geographic locations, such as a data structure including a geographic latitude and longitude. In an example, the location may be a relative location with respect to the access points.

These operations of method 500 may also be performed by the device 202, access points 204, 208, 210, or a combination of processors in communication with device 202 of FIG. 2.

Optionally, method 500 may include one or more operations defined by any of a variety of network protocols and standards in licensed or unlicensed spectrum bands, including Wi-Fi P2P communications performed in connection with an IEEE 802.11 standard (for example, Wi-Fi Direct communications facilitated by software access points (Soft APs)), 3GPP LTE/LTE-A communications (for example, LTE Direct (LTE-D) communications established in a portion of an uplink segment or other designated resources), machine-to-machine (M2M) communications performed in connection with an IEEE 802.16 standard, and the like.

Though arranged serially in the example of FIG. 5, other examples may reorder the operations, omit one or more operations, and/or execute two or more operations in parallel using multiple processors or a single processor organized as two or more virtual machines or sub-processors. Moreover, still other examples may implement the operations as one or more specific interconnected hardware or integrated circuit modules with related control and data signals communicated between and through the modules. Thus, any process flow is applicable to software, firmware, hardware, and hybrid implementations.

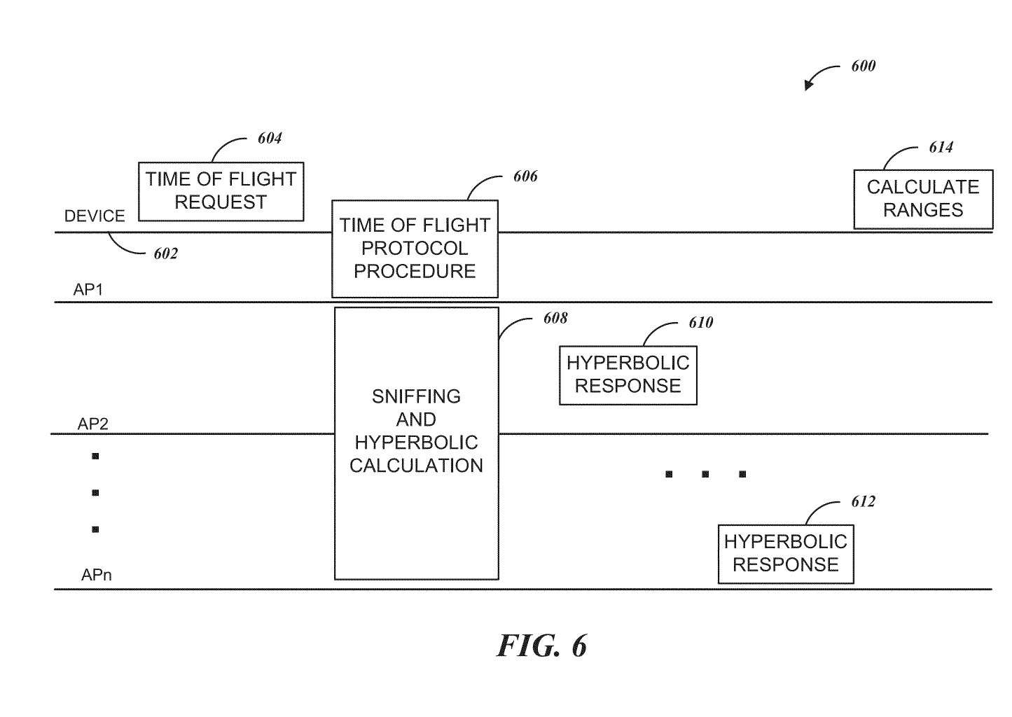

FIG. 6 is a diagram illustrating an example interaction between a device 602 and multiple access points in accordance with some embodiments.

Device 602, such as a communication station (STA) or user equipment (UE) device may broadcast a time of flight (TOF) request 604. In an example, the TOF request 604 may be transmitted to any available access point or base station. In an example, the TOF request 604 may be directed to a specific access point or base station, e.g., AP1.

Upon receipt of the TOF request 604, AP1 may begin a time of flight procedure protocol 606. The TOF procedure protocol 606 may include an exchange of one or more packets between the device 602 and AP1.

Upon receipt of the TOF request 604, one or more other access points, e.g., AP2 through APn, may begin sniffing for any packets that are transmitted in response to the TOF request 604, and in response to such packets performing a hyperbolic calculation to determine a range between the device 602 and the one or more other access points.

At 610, AP1 may transmit a hyperbolic response to the device 602. The hyperbolic response may include a time value indicating when AP1 received the TOF request 604 and a time value indicating when AP1 transmitted the hyperbolic response to the device 602.

At 612, the one or more other access points may transmit a hyperbolic response to the device 602. In an example, the hyperbolic response may include a time value indicating when the one or more other access points received the TOF request 604 and an access point specific time value indicating when one or more other access points transmitted the hyperbolic response to the device 602. In an example, the hyperbolic response may include the results of a calculation performed by the one or more other access points to determine or estimate a distance between the one or more other access points and AP1, or a distance between the one or more other access points and the device 602. In an example, the hyperbolic response may include a known geographic location (e.g., a pair of latitude and longitude coordinates) of the one or more other access points.

At 614, the device 602 may calculate ranges from the device 602 to each access point. In an example, the device 602 may calculate its location based at least in part on the ranges calculated by the device 602. In an example, the device 602 may determine a distance between the one or more access points, including AP1, by performing a comparison of the time values included in the hyperbolic response from each access point. In an example, the device 602 may determine its location with respect to the one or more access points based at least in part on the results of the comparison.

Although the preceding examples indicated the use of device-to-device communications in connection with 3GPP and 802.11 standard communications, it will be understood that a variety of other communication standards capable of facilitating device-to-device, machine-to-machine, and P2P communications may be used in connection with the presently described techniques. These standards include, but are not limited to, standards from 3GPP (e.g., LTE, LTE-A, HSPA+, UMTS), IEEE 802.11 (e.g., 802.11a, 802.11b, 802.11g, 802.11n, 802.11ac), 802.16 (e.g., 802.16p), or Bluetooth (e.g., Bluetooth 4.0, or other standard defined by the Bluetooth Special Interest Group) standards families. Bluetooth, as used herein, may refer to a short-range digital communication protocol defined by the Bluetooth Special Interest Group, the protocol including a short-haul wireless protocol frequency-hopping spread-spectrum (FHSS) communication technique operating in the 2.4 GHz spectrum.

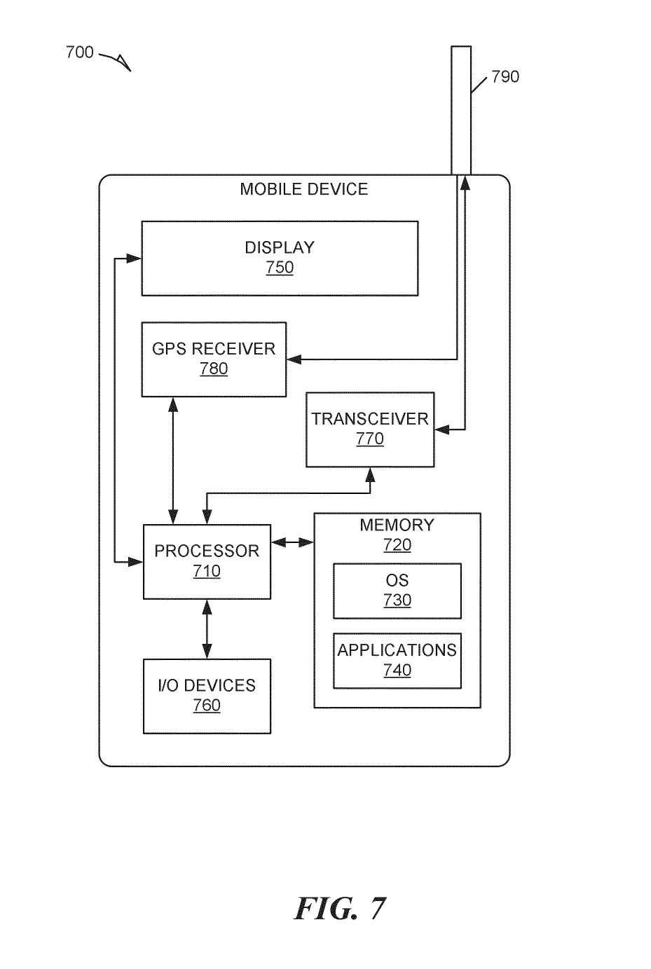

FIG. 7 is a block diagram illustrating a mobile device 700, upon which any one or more of the techniques (e.g., methodologies) discussed herein may be performed. The mobile device 700 may include a processor 710. The processor 710 may be any of a variety of different types of commercially available processors suitable for mobile devices, for example, an XScale architecture microprocessor, a Microprocessor without Interlocked Pipeline Stages (MIPS) architecture processor, or another type of processor. A memory 720, such as a Random Access Memory (RAM), a Flash memory, or other type of memory, is typically accessible to the processor 710. The memory 720 may be adapted to store an operating system (OS) 730, as well as application programs 740. The OS 730 or application programs 740 may include instructions stored on a computer readable medium (e.g., memory 720) that may cause the processor 710 of the mobile device 700 to perform any one or more of the techniques discussed herein. The processor 710 may be coupled, either directly or via appropriate intermediary hardware, to a display 750 and to one or more input/output (I/O) devices 760, such as a keypad, a touch panel sensor, a microphone, etc. Similarly, in an example embodiment, the processor 710 may be coupled to a transceiver 770 that interfaces with an antenna 790. The transceiver 770 may be configured to both transmit and receive cellular network signals, wireless data signals, or other types of signals via the antenna 790, depending on the nature of the mobile device 700. Further, in some configurations, a GPS receiver 780 may also make use of the antenna 790 to receive GPS signals.

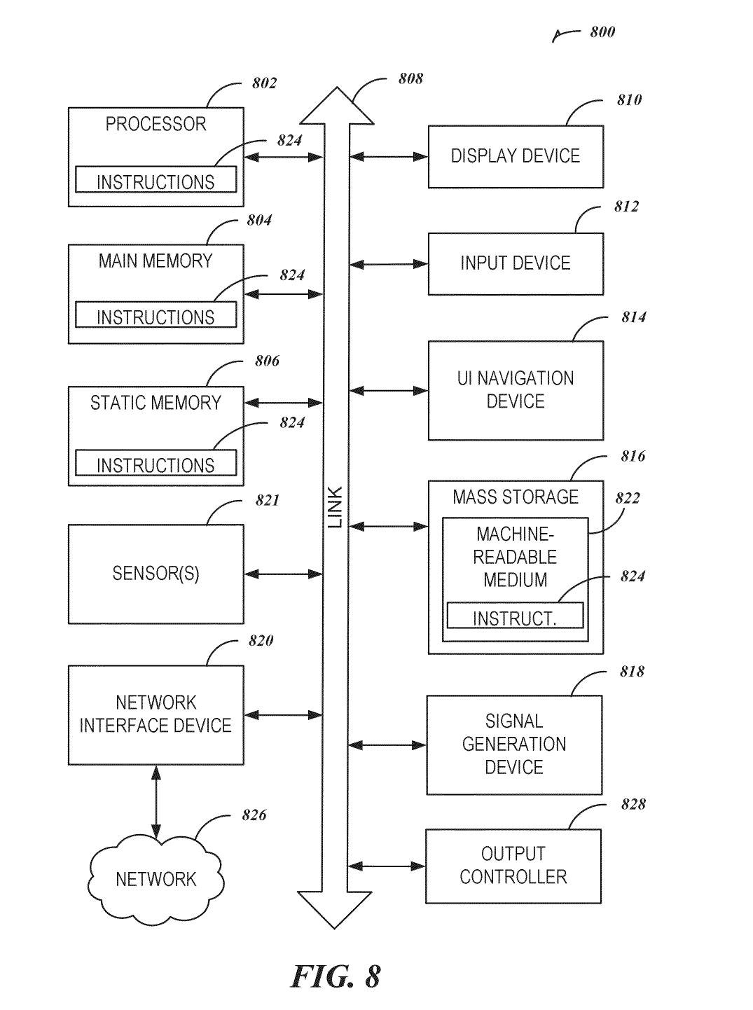

FIG. 8 illustrates a block diagram of an example machine 800 upon which any one or more of the techniques (e.g., methodologies) discussed herein may be performed. In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. The machine 800 may be a personal computer (PC), a tablet PC, a Personal Digital Assistant (PDA), a mobile telephone, a web appliance, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside (1) on a non-transitory machine-readable medium or (2) in a transmission signal. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 800 may include a hardware processor 802 (e.g., a processing unit, a graphics processing unit (GPU), a hardware processor core, or any combination thereof), a main memory 804, and a static memory 806, some or all of which may communicate with each other via a link 808 (e.g., a bus, link, interconnect, or the like). The machine 800 may further include a display device 810, an input device 812 (e.g., a keyboard), and a user interface (UI) navigation device 814 (e.g., a mouse). In an example, the display device 810, input device 812, and UI navigation device 814 may be a touch screen display. The machine 800 may additionally include a mass storage (e.g., drive unit) 816, a signal generation device 818 (e.g., a speaker), a network interface device 820, and one or more sensors 821, such as a global positioning system (GPS) sensor, camera, video recorder, compass, accelerometer, or other sensor. The machine 800 may include an output controller 828, such as a serial (e.g., universal serial bus (USB), parallel, or other wired or wireless (e.g., infrared (IR)) connection to communicate or control one or more peripheral devices (e.g., a printer, card reader, etc.).

The mass storage 816 may include a machine-readable medium 822 on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the mass storage 816 may constitute machine-readable media.

While the machine-readable medium 822 is illustrated as a single medium, the term “machine readable medium” may include a single medium or multiple media (e.g., a centralized or distributed database, and/or associated caches and servers) that configured to store the one or more instructions 824.

The term “machine-readable medium” may include any tangible medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). The term “transmission medium” shall be taken to include any intangible medium that is capable of storing, encoding or carrying instructions for execution by the machine 800, and includes digital or analog communications signals or other intangible medium to facilitate communication of such software.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media.

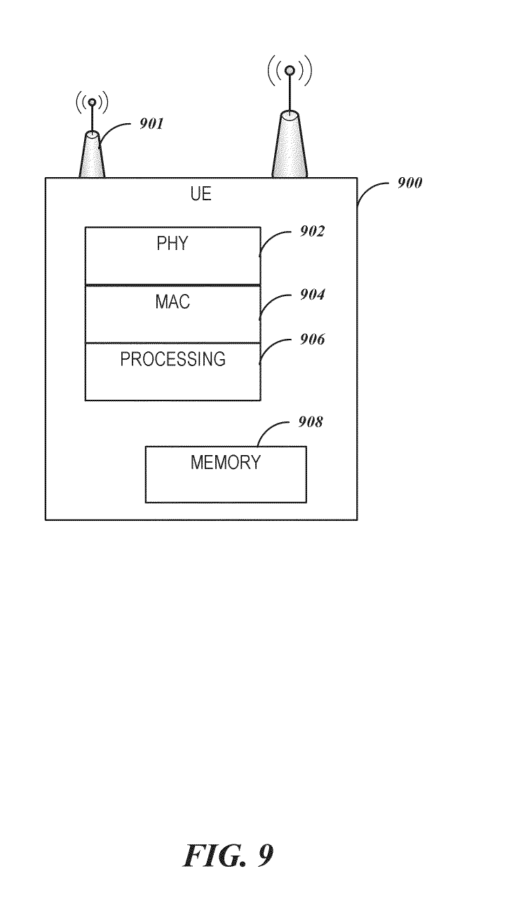

FIG. 9 illustrates a functional block diagram of a UE 900 in accordance with some embodiments. The UE 900 may be suitable for use as device 112 (FIG. 1) or device 202 (FIG. 2). The UE 900 may include physical layer circuitry 902 for transmitting and receiving signals to and from eNBs using one or more antennas 901. UE 900 may also include processing circuitry 906 that may include, among other things a channel estimator. UE 900 may also include a memory 908. The processing circuitry may be configured to determine several different feedback values discussed below for transmission to the eNB. The processing circuitry may also include a media access control (MAC) layer 904.

In some embodiments, the UE 900 may include one or more of a keyboard, a display, a non-volatile memory port, multiple antennas, a graphics processor, an application processor, speakers, and other mobile device elements. The display may be an LCD screen including a touch screen.

The one or more antennas 901 utilized by the UE 900 may comprise one or more directional or omnidirectional antennas, including, for example, dipole antennas, monopole antennas, patch antennas, loop antennas, microstrip antennas or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated to take advantage of spatial diversity and the different channel characteristics that may result between each of antennas and the antennas of a transmitting station. In some MIMO embodiments, the antennas may be separated by up to 1/10 of a wavelength or more.

Although the UE 900 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Embodiments may be implemented in one or a combination of hardware, firmware and software. Embodiments may also be implemented as instructions stored on a computer-readable storage medium, which may be read and executed by at least one processor to perform the operations described herein. A computer-readable storage medium may include any non-transitory mechanism for storing information in a form readable by a machine (e.g., a computer). For example, a computer-readable storage medium may include read-only memory (ROM), random-access memory (RAM), magnetic disk storage media, optical storage media, flash-memory devices, and other storage devices and media. In these embodiments, one or more processors of the UE 900 may be configured with the instructions to perform the operations described herein.

In some embodiments, the UE 900 may be configured to receive OFDM communication signals over a multicarrier communication channel in accordance with an OFDMA communication technique. The OFDM signals may comprise a plurality of orthogonal subcarriers. In some broadband multicarrier embodiments, eNBs (including macro eNB and pico eNBs) may be part of a broadband wireless access (BWA) network communication network, such as a Worldwide Interoperability for Microwave Access (WiMAX) communication network or a 3rd Generation Partnership Project (3GPP) Universal Terrestrial Radio Access Network (UTRAN) Long-Term-Evolution (LTE) or a Long-Term-Evolution (LTE) communication network, although the scope of the inventive subject matter described herein is not limited in this respect. In these broadband multicarrier embodiments, the UE 900 and the eNBs may be configured to communicate in accordance with an orthogonal frequency division multiple access (OFDMA) technique. The UTRAN LTE standards include the 3rd Generation Partnership Project (3GPP) standards for UTRAN-LTE, release 8, March 2008, and release 10, December 2010, including variations and evolutions thereof.

In some LTE embodiments, the basic unit of the wireless resource is the Physical Resource Block (PRB). The PRB may comprise 12 sub-carriers in the frequency domain×0.5 ms in the time domain. The PRBs may be allocated in pairs (in the time domain). In these embodiments, the PRB may comprise a plurality of resource elements (REs). A RE may comprise one sub-carrier×one symbol.

Two types of reference signals may be transmitted by an eNB including demodulation reference signals (DM-RS), channel state information reference signals (CIS-RS) and/or a common reference signal (CRS). The DM-RS may be used by the UE for data demodulation. The reference signals may be transmitted in predetermined PRBs.

In some embodiments, the OFDMA technique may be either a frequency domain duplexing (FDD) technique that uses different uplink and downlink spectrum or a time-domain duplexing (TDD) technique that uses the same spectrum for uplink and downlink.

In some other embodiments, the UE 900 and the eNBs may be configured to communicate signals that were transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, the UE 900 may be part of a portable wireless communication device, such as a PDA, a laptop or portable computer with wireless communication capability, a web tablet, a wireless telephone, a wireless headset, a pager, an instant messaging device, a digital camera, an access point, a television, a medical device (e.g., a heart rate monitor, a blood pressure monitor, etc.), or other device that may receive and/or transmit information wirelessly.

In some LTE embodiments, the UE 900 may calculate several different feedback values which may be used to perform channel adaption for closed-loop spatial multiplexing transmission mode. These feedback values may include a channel-quality indicator (CQI), a rank indicator (RI) and a precoding matrix indicator (PMI). By the CQI, the transmitter selects one of several modulation alphabets and code rate combinations. The RI informs the transmitter about the number of useful transmission layers for the current MIMO channel, and the PMI indicates the codebook index of the precoding matrix (depending on the number of transmit antennas) that is applied at the transmitter. The code rate used by the eNB may be based on the CQI. The PMI may be a vector that is calculated by the UE and reported to the eNB. In some embodiments, the UE may transmit a physical uplink control channel (PUCCH) of format 2, 2a or 2b containing the CQI/PMI or RI.

In these embodiments, the CQI may be an indication of the downlink mobile radio channel quality as experienced by the UE 900. The CQI allows the UE 900 to propose to an eNB an optimum modulation scheme and coding rate to use for a given radio link quality so that the resulting transport block error rate would not exceed a certain value, such as 10%. In some embodiments, the UE may report a wideband CQI value which refers to the channel quality of the system bandwidth. The UE may also report a sub-band CQI value per sub-band of a certain number of resource blocks which may be configured by higher layers. The full set of sub-bands may cover the system bandwidth. In case of spatial multiplexing, a CQI per code word may be reported.

In some embodiments, the PMI may indicate an optimum precoding matrix to be used by the eNB for a given radio condition. The PMI value refers to the codebook table. The network configures the number of resource blocks that are represented by a PMI report. In some embodiments, to cover the system bandwidth, multiple PMI reports may be provided. PMI reports may also be provided for closed loop spatial multiplexing, multi-user MIMO and closed-loop rank 1 precoding MIMO modes.

In some cooperating multipoint (CoMP) embodiments, the network may be configured for joint transmissions to a UE in which two or more cooperating/coordinating points, such as remote-radio heads (RRHs) transmit jointly. In these embodiments, the joint transmissions may be MIMO transmissions and the cooperating points are configured to perform joint beamforming.

The example embodiments discussed herein may be utilized by wireless network access providers of all types including, but not limited to, mobile broadband providers looking to increase cellular offload ratios for cost-avoidance and performance gains, fixed broadband providers looking to extend their coverage footprint outside of customers' homes or businesses, wireless network access providers looking to monetize access networks via access consumers or venue owners, public venues looking to provide wireless network (e.g., Internet) access, or digital services (e.g. location services, advertisements, entertainment, etc.) over a wireless network, and business, educational or non-profit enterprises that desire to simplify guest Internet access or Bring-Your-Own-Device (BYOD) access.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1-29. (canceled)

30. A wireless communication method comprising:
transmitting, from an access point, a network identifier;
receiving, at the access point, a request from a communication station (STA) to establish a communication session between the access point and the STA; and
establishing a communication session between the access point and the STA;
wherein establishing a communication session includes:
calculating a time of arrival corresponding to the network equipment detecting the time of flight request;
determining a time of departure;
transmitting a response to the time of flight request to the device, the response including the time of arrival and the time of departure; and
determining a location of the device based at least in part on the time of arrival and the time of departure;
wherein the response to the time of flight request to the device is performed only once when establishing the communication session.

31. The method of claim 30, further comprising:
transmitting the location of the access point to the STA.

32. The method of claim 30, further comprising:
receiving a location of the STA from the STA; and
providing the location of the STA to a second access point.

33. The method of claim 30, further comprising:
receiving, at the access point from a network device, a first arrival time of the request at the network device, and a second arrival time corresponding to a response to the request from the access point received at the network device;
wherein determining the location of the device is based at least in part on the first arrival time and the second arrival time.

34. A communication station (STA), comprising a memory coupled to processing circuitry, the processing circuitry arranged to communicate with a network, to establish an wireless connection with an access point coupled to the network, and determine a location of the STA independent from the network, by performing operations to:
transmit a time of flight (TOF) request to the access point;
determine a departure time for the TOF request;
receive, in response to the TOF request, a TOF reply, the TOF reply including an request time corresponding to the receipt of the TOF request by the access point and a reply time corresponding to the departure of the TOF reply from the access point to the STA;
determine an arrival time at the STA corresponding to the receipt of the TOF reply at the STA;
receiving, at the STA from a second access point, an unsolicited TOF notification including: a first time corresponding to the TOF request being detected by the second access point, and a second time corresponding to the TOF reply being detected by the second access point; and
determine the location of the STA based at least in part on the departure time, the request time, the reply time, the arrival time, the first time and the second time.

35. The STA of claim 34, wherein the processing circuitry is further arranged to perform operations to:
calculate a distance between the STA and the access point based at least on the departure time, the request time, the reply time, the arrival time.

36. The STA of claim 35, wherein the processing circuitry is further arranged to perform operations to:
calculate a second distance between the STA and the second access point based at least on the departure time, the first time, the second time, and a notification time corresponding to the receipt of the unsolicited TOF notification by the STA.

37. The STA of claim 34, wherein the time of flight request is included in a connection request transmitted from the STA to the access point.

38. The STA of claim 34, wherein the processing circuitry is further arranged to perform operations to:
provide the location of the STA to the access point.

39. The STA of claim 34, wherein the wireless connection is established at least in part by performing wireless communications in accordance with a standard from: a 3GPP Long Term Evolution or Long Term Evolution-Advanced standards family, a standard from an IEEE 802.11 standards family, a standard from an IEEE 802.16 standards family, or a standard from a Bluetooth Special Interest Group standards family.

40. The STA of any of claim 34, further comprising user equipment (UE); wherein the processing circuitry is further configured to perform a multiple-input and multiple-output (MIMO) multiplexing technique.

41. A method performed by a communication station (STA) for determining a location of the STA, the method comprising:
discovering, with a wireless receiver of the STA, a wireless network;
transmitting, by the STA, a time-of-flight TOF request to an access point of the wireless network;
receiving, by the STA, a TOF response to the TOF request, the TOF response including a first time of arrival and a first time of departure;
receiving, by the STA, an unsolicited TOF notification from a second access point, the unsolicited TOF notification including a second time of arrival and a second time of departure;
calculating a first distance from the access point based at least in part on the first time of arrival and the first time of departure, and a second distance based at least in part on the second time of arrival and the second time of departure; and
determining the location of the STA based at least in part on the first distance and the second distance.

42. The method of claim 41, further comprising:
receiving, by the STA, a second TOF notification from a third access point, the second TOF notification including a third time of arrival and a third time of departure; and
calculating a third distance from the third access point based at least in part on the third time of arrival and the third time of departure;
wherein determining the location of the STA based at least in part on the first distance, the second distance, and the third distance.

43. The method of claim 41, further comprising:
establishing a network connection with the access point; and
receiving location information from the access point, the location information including a geographical location of the access point.

44. The method of claim 41, wherein the request, by the STA for the time-of-flight exchange with the access point of the wireless network is performed only once per channel.

45. The method of any of claim 44, wherein the STA does not establish a network connection with the second access point or the third access point.

46. The method of claim 42, wherein the STA is included in a user equipment (UE), and the network connection includes a wireless network connection performing wireless communications in accordance with a standard from: a 3GPP Long Term Evolution or Long Term Evolution-Advanced standards family, a standard from an IEEE 802.11 standards family, a standard from an IEEE 802.16 standards family, or a standard from a Bluetooth Special Interest Group standards family.

47. An indoor location system comprising:
a device having a wireless communication module;
a first wireless access point coupled to a network;
a second wireless access point coupled to the network;
wherein the wireless communication module is configured to request timing information from the first wireless access point, the first wireless access point is configured to provide timing information to the device in response to receiving a request from the device, and the second wireless access point is configured to transmit an unsolicited timing information to the device in response to detecting the request.

48. The indoor location system of claim 47, wherein the timing information includes an arrival time corresponding to the first wireless access point receiving the request, and a reply time corresponding to the transmission of the response to receiving the request from the device.

49. The indoor location system of claim 48, wherein the unsolicited timing information includes an arrival time corresponding to the second wireless access point receiving the request, and a reply time corresponding to the transmission of the unsolicited timing information by the second wireless access point to the device.

50. The indoor location system of claim 48, wherein the device and first wireless access point are configured to establish a network connection; the network connection not including a connection between the device and the second wireless access point.

51. The indoor location system of claim 50, wherein the network connection includes a wireless network connection performing wireless communications in accordance with a standard from: a 3GPP Long Term Evolution or Long Term Evolution-Advanced standards family, a standard from an IEEE 802.11 standards family, a standard from an IEEE 802.16 standards family, or a standard from a Bluetooth Special Interest Group standards family.

52. A network equipment comprising:
processing circuitry;
an antenna; and
a transceiver coupled to the processing circuitry and the antenna;
wherein the processing circuitry is configured to:
detect a time of flight request from a device by the transceiver;
calculate a time of arrival corresponding to the network equipment detecting the time of flight request;
determine a time of departure;
transmit a response to the time of flight request to the device, the response including the time of arrival and the time of departure;
refrain from establishing a network connection with the device; and
determine a location of the device based at least in part on the time of arrival and the time of departure.

53. The network equipment of claim 52, wherein the response further includes the location of the network equipment.

54. The network equipment of claim 52, wherein the processing circuitry is further configured to:
communicate the response to a second network device.
